(19) United States
(12) Patent Application Publication
(10) Pub. No.: US 2025/0214544 A1
(43) Pub. Date: Jul. 3, 2025

(54) VEHICLE WASHING SYSTEM AND METHOD

(71) Applicant: Jud Smith, Greencastle, IN (US)

(72) Inventor: Jud Smith, Greencastle, IN (US)

(73) Assignee: Jud Smith, Greencastle, IN (US)

(21) Appl. No.: 18/828,270

(22) Filed: Sep. 9, 2024

Related U.S. Application Data
(60) Provisional application No. 63/581,372, filed on Sep. 8, 2023.

(51) Int. Cl. B60S 3/06

(52) U.S. Cl. CPC B60S 3/063

(57) ABSTRACT

A pivot arm assembly for a washing apparatus includes a pivot arm assembly having a vertical support; a pivot arm extending from the vertical support and pivotable with respect to the vertical support; a spindle extending from the pivot arm, the spindle including an upper spindle portion and a lower spindle portion, the lower spindle portion being arranged at an acute angle with respect to the upper spindle portion; a mitter frame coupled to the pivot arm at the lower spindle portion and a plurality of mitter strips attached to and extending downward from the mitter frame; and the pivot arm being pivotable about at least a 90 degree range of motion with respect to the vertical support.

### BRIEF DESCRIPTION OF THE DRAWINGS

FIG. 1 is a top view of a vehicle washing system.

FIG. 2 is a front view of a mitter system of the vehicle washing system of FIG. 1.

FIG. 3 is a bottom view of a mitter frame of the mitter system of FIG. 2.

FIG. 4 is a perspective view of a top washing apparatus of the vehicle washing system of FIG. 1.

FIG. 5 is a perspective view of the planetary gear arrangement of the top washing apparatus of FIG. 4.

FIG. 6A is a diagrammatic side view of the top washing apparatus of FIG. 4.

FIG. 6B is a diagrammatic top view of the top washing apparatus of FIG. 4.

FIG. 7 is a front view of a side washing apparatus of the vehicle washing system of FIG. 1.

FIG. 8A is a diagrammatic side view of the side washing apparatus of FIG. 7.

FIG. 8B is a diagrammatic top view of the side washing apparatus of FIG. 7.

FIG. 9 is a front view of a wrap around washing apparatus of the vehicle washing system of FIG. 1.

FIG. 10 is a front view of the frame of the wrap around washing apparatus of FIG. 9.

FIG. 11A is a diagrammatic side view of the wrap around washing apparatus of FIG. 9.

FIG. 11B is a diagrammatic top view of the wrap around washing apparatus of FIG. 9.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Directional terms, such as forward, rearward, top, bottom, etc., may be used in this description with reference to the specific embodiment shown and used for purposes of clarity. It should be recognized that these terms are not meant to be limiting.

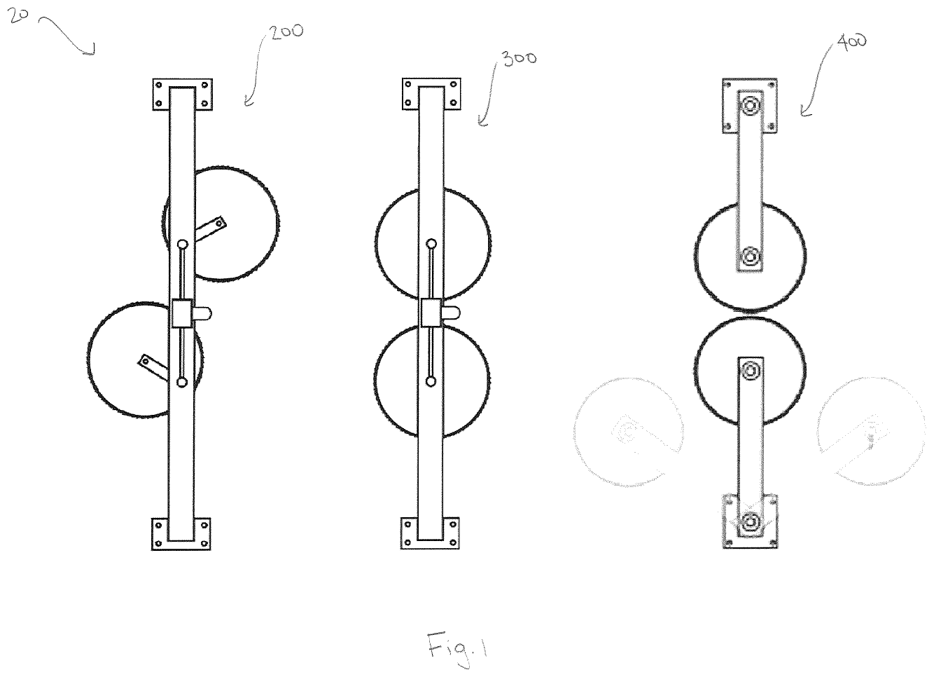

FIG. 1 shows a diagram of a vehicle washing system 20 that includes one or more washing apparatuses for providing different movements of mitting systems to wash a vehicle. In the embodiment shown, the vehicle washing system 20 includes a top washing apparatus 200, a side washing apparatus 300, and a wrap around washing apparatus 400. In other embodiments, the vehicle washing system 20 may include a combination of one or more of a top washing apparatus 200, a side washing apparatus 300, and/or a wrap around washing apparatus 400. The washing apparatuses 200, 300, 400 may be used in combination or used independently as part of the vehicle washing system to provide a desired cleaning of the vehicle.

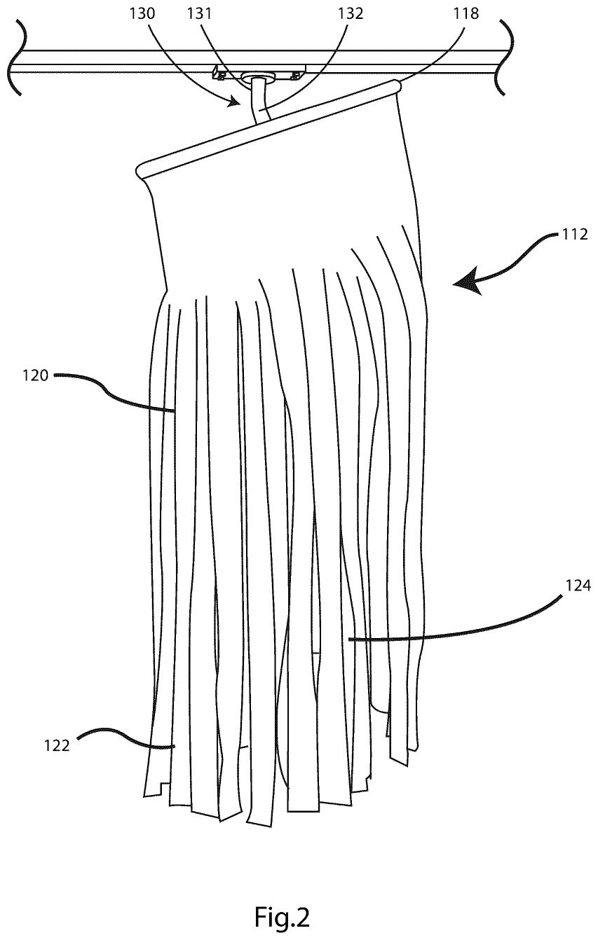

The vehicle washing system 20 includes one or more apparatuses that each include one or more mitter systems 112, shown in FIG. 2. The mitter systems 112 may be used with each of the washing apparatuses in the vehicle washing system 20 as a cleaning element that is used to clean a vehicle. The mitter system 112 includes a mitter frame 118 to which a number of mitter strips 120 are attached. One end of the mitter strip 120 is attached to the mitter frame 118 and the other end of the mitter strip 120 is freely suspended from the mitter frame 118 so that the mitter strip 120 hangs vertically down from the mitter frame 118. In some embodiments, the mitter strips 120 are made from a woven or non-woven fabric. In other embodiments, the mitter strips 120 may be made from a thermoplastic. In some embodiments, the mitter system 112 may have a diameter between 24 in. and 72 in.

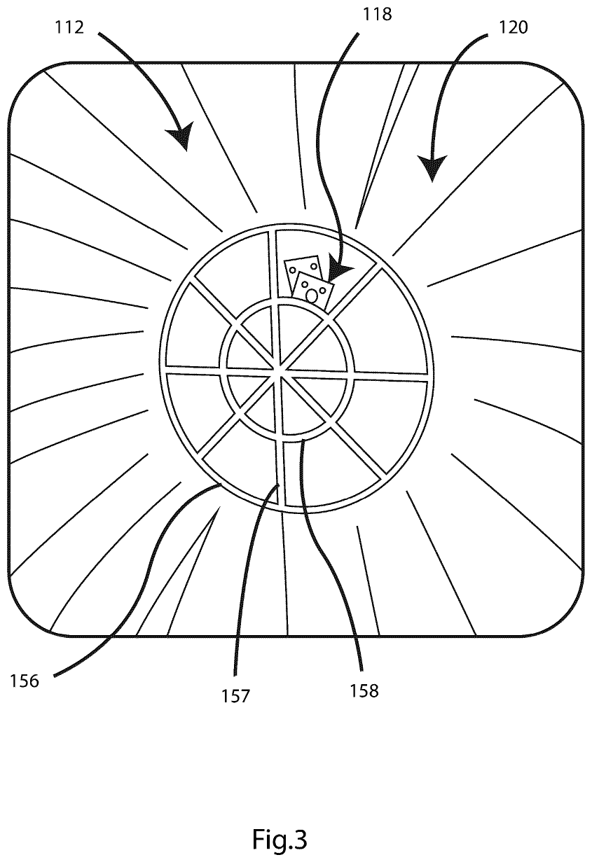

As shown in FIG. 3, the mitter frame 118 includes a circular rim 156 and one or more connectors 157 that extend from the rim 156 to a central hub 158. As illustrated in FIG. 2, a spindle 130 may extend from the central hub 158 of the mitter frame 118 to attach the mitter system 112 to a washing apparatus. In some instances, the spindle 130 (FIG. 2) may include an upper spindle portion 131 and may also include a lower spindle portion 132. The upper spindle portion 131 may be straight, and extend substantially perpendicularly with respect to the central hub 158. The lower spindle portion 132 may be situated at an angle with respect to the upper spindle portion 131 and the central hub 158. The angled lower spindle portion 132 of the spindle 130 may support the mitter frame 118 so as to be angled or tilted.

The mitter strips 120 attached to the mitter frame 118 may extend at various lengths with respect to the mitter frame 118. In a preferred embodiment, the mitter strips 120 are arranged on frame 118 in a circular pattern. This facilitates the action of the mitter systems 112 when rotated, although other arrangements may also be used. As shown in FIG. 2, in one embodiment there are outer mitter strips 122 and inner mitter strips 124. In an embodiment, the inner mitter strips 122 are shorter than the outer mitter strips 124 and therefore provide more vertical cleaning positions. In some embodiments, the mitter strips 120 may also include cleaning brushes or other additional elements that improve the cleaning ability of the mitter strip 120. For example, the mitter strips 120 may include cleaning brushes such as the brushes that are disclosed in pending US Patent Application, Ser. No. 17/845,227, filed Jun. 21, 2022, the entirety of the disclosure of which is hereby incorporated by reference.

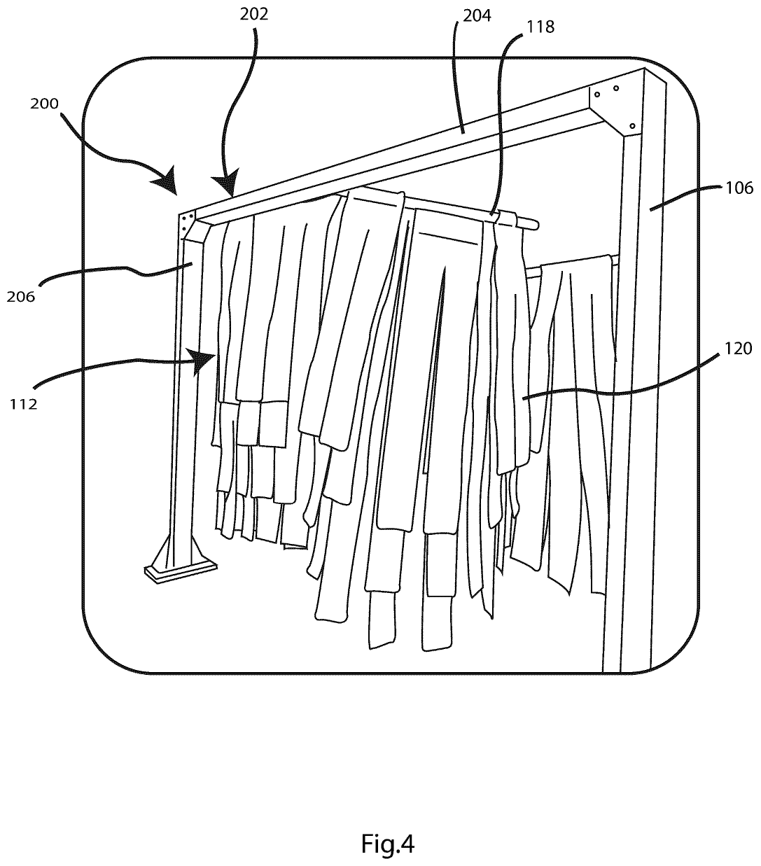

The top washing apparatus 200 is shown in FIG. 4. The top washing apparatus 200 includes a frame 202 that is formed by a pair of spaced vertical supports 206 and a horizontal support 204 extending between the vertical supports 206. In the embodiment shown, the horizonal support 204 extends between the vertical supports 206 at an end of the vertical supports 206 so that the horizontal support 204 is positioned at a height about a support surface that is sufficient to allow a vehicle to fit underneath the horizontal support 204. In other embodiments, other suitable methods of supporting the horizontal support 204 at a suitable height for washing a vehicle may be used rather than the vertical supports 206. In some embodiments, the frame 202 may be built using high-strength, corrosion resistant aluminum.

The top washing apparatus 200 may include one or more of the mitter systems 112 described in FIGS. 2-3. In the embodiment shown, the top washing apparatus 200 includes a pair of mitter systems 112 which are supported by the horizontal support 204 of the frame 202. The mitter systems 112 are arranged adjacent to each other so that the mitter systems 112 may work together to clean the entire width of the vehicle. In some embodiments, the mitter systems 112 of the top washing apparatus 200 are configured to provide approximately 1 lb./ft.² of cloth pressure on a vehicle being washed.

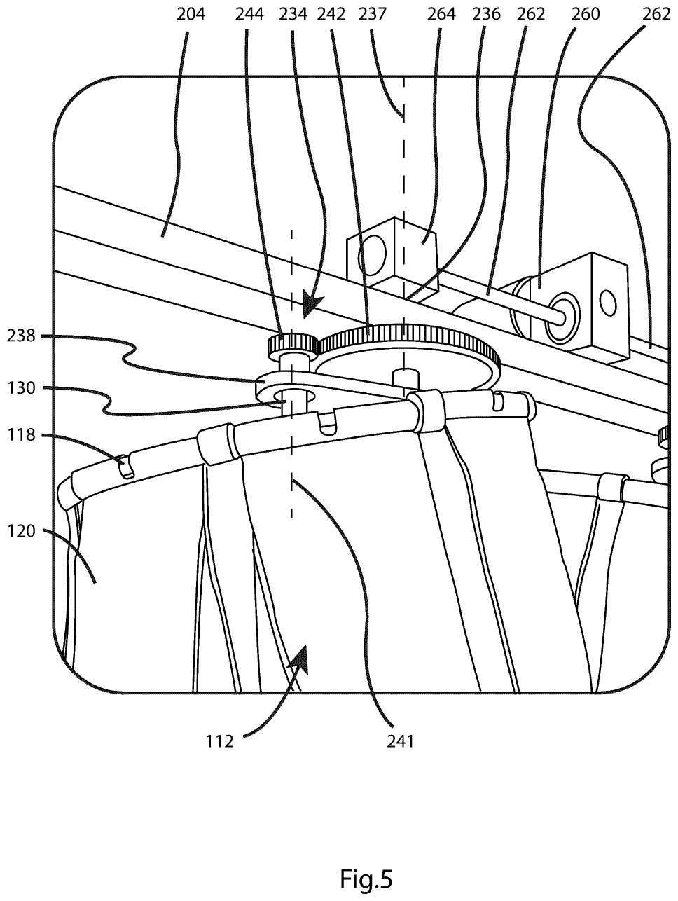

The mitter systems 112 are mounted to the horizontal support 204 of the frame 202 in a manner that provides unique, and highly effective, movement of the mitter strips 120 during cleaning. In general, the top washing apparatus 200 utilizes a planetary gear arrangement 234 to support and move the mitter systems 112. Various aspects of planetary gear arrangement 234 are shown in FIG. 5.

It is shown that top washing apparatus 200 includes, in one embodiment, a planetary gear arrangement 234 providing unique movement of the mitter systems. The planetary gear arrangement 234 is mounted to the horizontal support 204 of the frame 202. A first axle 236 is mounted to horizontal support 204 and is rotatable about a first vertical axis 237. A planetary pivot arm 238 has a first end and a second end, the first end being secured to first axle 236 to rotate with the first axle 236. The spindle 130 attached to the mitter frame 118 of the mitter system 112 is mounted to the second end of planetary pivot arm 238 and is rotatable about a second vertical axis 241.

Planetary gear arrangement 234 comprises a first gear 242 fixedly secured in a horizontal plane to horizontal support 204 and located coaxial with first axle 236. Planetary gear apparatus 234 further comprises a second gear 244 smaller than first gear 242. Second gear 244 is fixedly mounted to the spindle 130, and is rotatable about the second vertical axis 241. First gear 242 is engaged with second gear 244 such that rotation of planetary pivot arm 238 causes the spindle 130 and second gear 244 to be rotated by first gear 242.

The mitter frame 118 of mitter system 112 is mounted to the planetary gear arrangement 234 by the spindle 130; thus, allowing the mitter system 112 moves in two primary ways. First, the engagement of the second gear 244 with the first gear 242 results in a rotation of the mitter system 112 around the second axis 241, which corresponds with the rotation of the spindle 130 around its axis 241. Second, mitter frame 118 is mounted to the spindle 130, which is mounted to the second end of planetary pivot arm 238. This results in movement of the mitter frame 118 around the first axis 237.

The shape of the spindle 130 provides another manner of movement for the mitter system 112. Since the lower portion 132 of spindle 130 is bent at a slight angle to the rotational axis the angular position of the mitter frame is continuously changing as the spindle 130 rotates. The angled shape of the spindle 130 provides both rotational and up-and-down movement to the mitter strips 120. It will further be appreciated that the systems can be operated in the reverse direction. This may be particularly useful for enhancing the cleaning of a vehicle as it moves relative to the mitter systems 112.

The planetary gear system 234 is driven by a motor 260 that is supported on the horizontal support 204 of the frame 202. The motor 260 is operationally connected to a gear box 264 by a drive shaft 262. The gear box 264 is in mechanical communication with the first axle 236 of the planetary gear system 124, allowing for rotation of the first axle 236 upon operation of the motor 260. As shown, the motor 260 may be coupled to more than one drive shaft 262, allowing the motor 260 to drive multiple mitter systems 112 included in the top washing apparatus 200.

In some embodiments, the top washing apparatus 200 may have two mitter systems 112 and the motor 260 may drive the mitter systems 112 so that the mitter systems 112 rotate in opposite directions. However, in other embodiments, each of the mitter systems 112 may rotate in the same direction. In some instances, the motor 260 may be run in forward or reverse so that each mitter system 112 may either rotate clockwise or counterclockwise. In some embodiments, the top washing apparatus 200 may include an automatic stop-tension safety feature that stops rotational operation of the mitter systems if the mitter systems 112 get caught or tangled on the vehicle or a component of the vehicle.

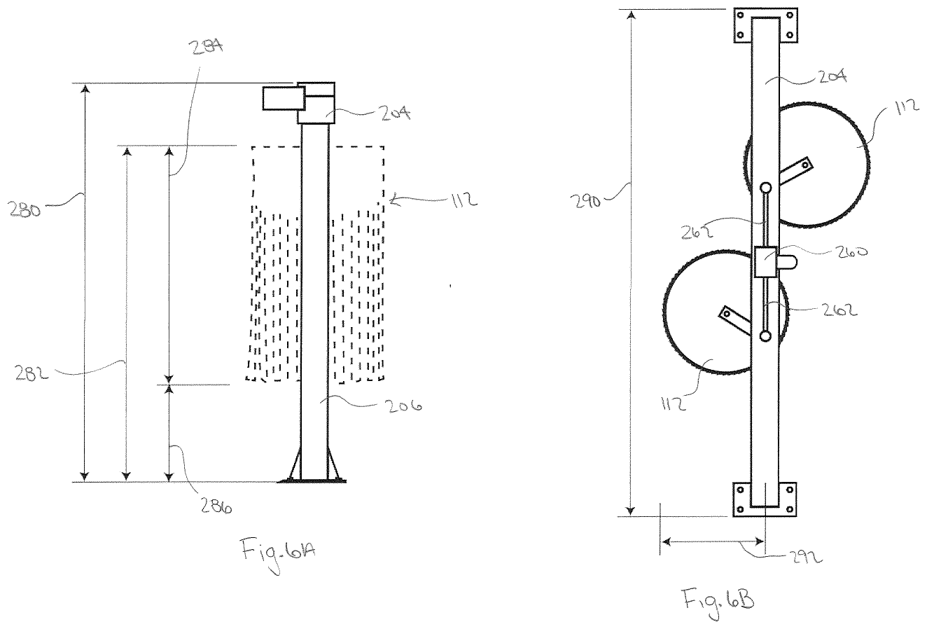

A diagram showing a side elevation view of the top washing apparatus 200 is shown in FIG. 6A, and a diagram showing a top plan view of the top washing apparatus 200 is shown in FIG. 6B. As shown in FIG. 6A, the top washing apparatus 200 has an apparatus height 280 that includes the height of the entire structure including the frame 202. The top washing apparatus 200 also includes an effective mitter height 282 that is measured from the top of the mitter system 110 to a support surface. The effective mitter height 282 includes a mitter height 284 that is measured from the top of the mitter system 112 to the bottom of the mitter system 112 and a floor to mitter height 286 that is measured from the support surface to the bottom of the mitter system 112.

As shown in FIG. 6B, the top washing apparatus 200 also has an apparatus width 290 that spans between the vertical supports 206 of the frame 202. The top washing apparatus 200 also has a mitter depth 292 measured from the front or the back a mitter system to the frame 202.

In a representative example, the apparatus height 280 may be equal to 11 feet while the effective mitter height 282 is 96 inches. The mitter height 284 may be equal to 70 inches and the floor to mitter height 286 may be equal to 26 inches. Additionally, in this embodiment, the apparatus width 290 may be equal to 12.5 ft, and the mitter depth 292 may be equal to 28 inches. This allows the top washing apparatus 200 to only require 4 feet and 8 inches of tunnel length in the vehicle washing system 20.

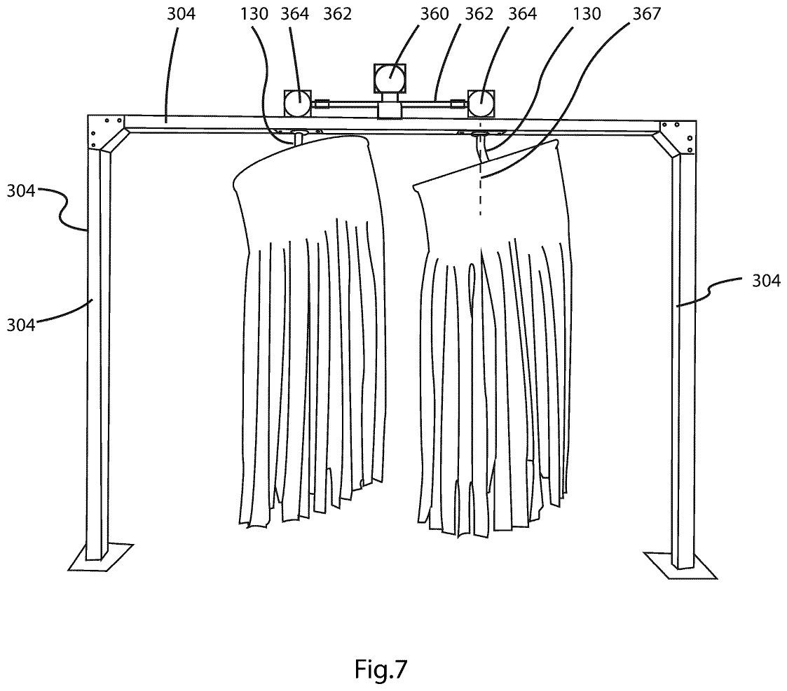

The side washing apparatus 300 is illustrated in FIG. 7 and may be used to clean the front, corner, sides, and/or rear of a vehicle. The side washing apparatus 300 includes a frame 302 similar to the frame 202 for the top washing apparatus 200. The frame 302 includes two vertical supports 306 and a horizontal support 304 that extends between top ends of the vertical supports 306. A motor 360 is positioned on the horizonal support 304 and one or more drive rods 362 extend from the motor 360. In the embodiment shown, the drive rods 362 are parallel to the horizonal support 304. Each of the drive rods 362 are mechanically connected to a gear box 364. In some embodiments, the frame 202 may be built using high-strength, corrosion resistant aluminum.

The side washing apparatus 300 includes a pair of mitter systems 112, described above and shown in FIG. 1. The mitter systems 112 may be supported by the horizonal support 304 of frame 302. Although, in the embodiment shown, the side washing apparatus 300 includes a pair of mitter systems 112, in other embodiments, a single mitter system 112 may be used or a more than two mitter systems 112 may be supported. In some embodiments, the mitter systems 112 used in side washing apparatus 300 may each have mitter strips 120 with varying lengths, as described above. However, in other embodiments, the side washing apparatus 300 may include mitter systems 112 that have mitter strips 120 of a uniform length.

Each of the mitter systems 112 attaches to the horizontal support 304 of frame 302 at the spindle 130 of the mitter system 112. The spindle 130 is operatively attached to the motor 360 supported on the horizonal support 304 of the frame 302 through the gear box 364 and the drive rod 362. The spindle 130 shown includes the upper spindle portion 131 and the angled lower spindle portion 132 so that the mitter frame 118 is supported to be angled or tilted with respect to the horizonal support 304 of the frame 302.

Operation of the motor 360 causes rotation of the spindle 130. In some embodiments, the spindle 130 may be operated to rotate either clockwise or counterclockwise. Rotation of the spindle 130 causes rotation of the mitter frame 118 about a rotation axis 367 extending through the spindle 130. The mitter strips 120 rotate with the mitter frame 118 about the rotation axis 367. The tilt of the mitter frame 118 causes the mitter strips 120 to also move vertically as the mitter strips 120 rotate with the mitter frame 118 about the rotation axis 367.

In some embodiments, the side washing apparatus 300 may have two mitter systems 112 and the motor 360 may drive the mitter systems 112 so that the mitter systems 112 rotate in opposite directions. However, in other embodiments, each of the mitter systems 112 may rotate in the same direction. In some instances, the motor 360 may be run in forward or reverse so that each mitter system 112 may either rotate clockwise or counterclockwise. In some embodiments, the side washing apparatus 300 may include an automatic stop-tension safety feature that stops rotational operation of the mitter systems if the mitter systems 112 get caught or tangled on the vehicle or a component of the vehicle.

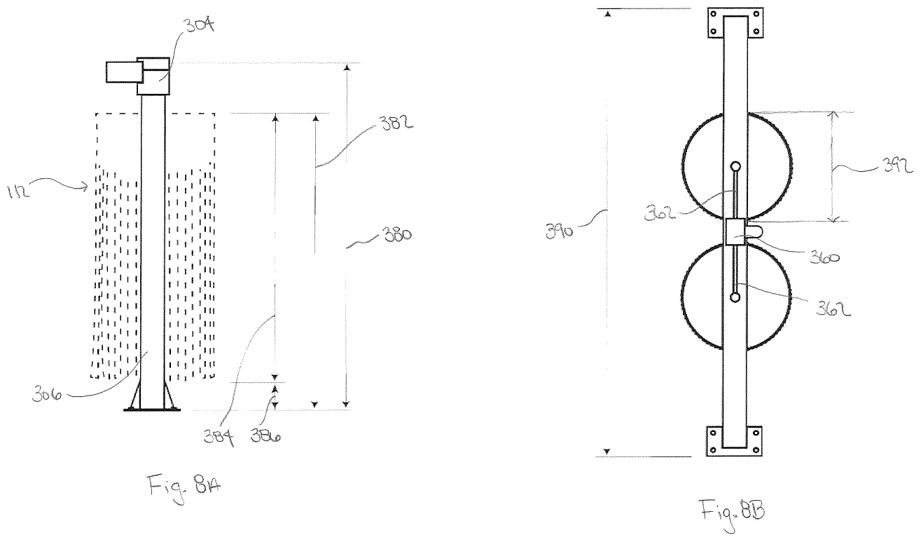

A diagram showing a side elevation view of the side washing apparatus 300 is shown in FIG. 8A, and a diagram showing a top plan view of the side washing apparatus 300 is shown in FIG. 8B. As shown in FIG. 8A, the side washing apparatus 300 has an apparatus height 380 that includes the height of the entire structure including the frame 302. The side washing apparatus 300 also includes an effective mitter height 382 that is measured from the top of the mitter system 112 to a support surface. The effective mitter height 382 includes a mitter height 384 that is measured from the top of the mitter system 112 to the bottom of the mitter system 112 and a floor to mitter height 386 that is measured from the support surface to the bottom of the mitter system 112.

As shown in FIG. 8B, the side washing apparatus 300 also has an apparatus width 390 that spans between the vertical supports 306 of the frame 302. Additionally, the mitter system 112 has a mitter diameter 392.

In a representative example, the apparatus height 380 may be equal to 11 feet while the effective mitter height 382 is 96 inches. The mitter height 384 may be equal to 90 inches and the floor to mitter height 386 may be equal to 6 inches. Additionally, in this example, the apparatus width 390 may be equal to 12.5 feet, and the mitter diameter 392 may be equal to 3 feet Therefore, the side washing apparatus 300 in this example only requires 3 feet of tunnel length within the vehicle washing system 20.

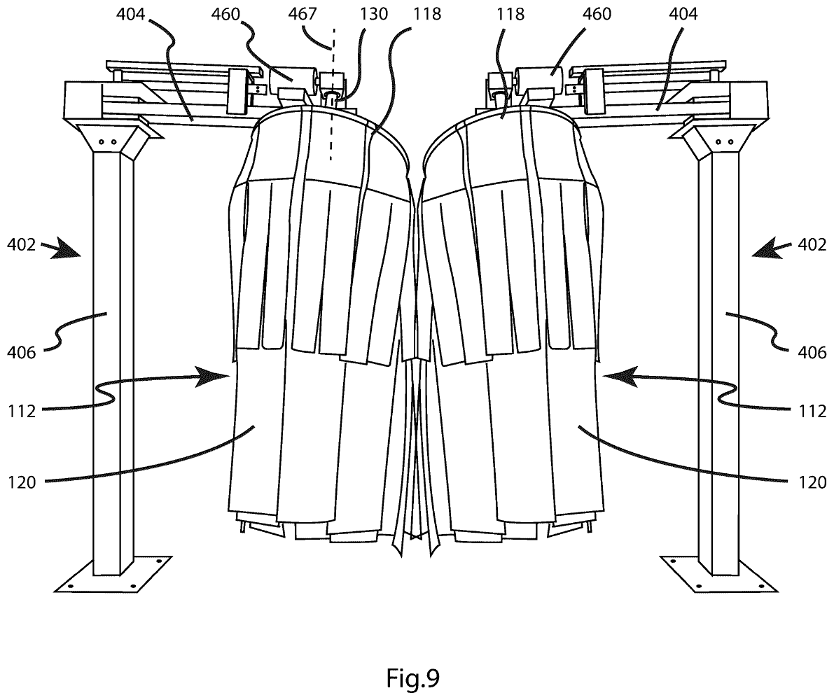

The wrap around washing apparatus 400 is shown in FIG. 9 and is capable of washing the front, side, and rear of the vehicle. The wrap around washing apparatus 400 includes two separate, opposed pivot arm assemblies 402. Each of the pivot arm assemblies 402 includes a pivot arm 404 that extends transversely from a vertical support 406. In the embodiment shown, the pivot arm 404 extends from a top edge of the vertical support 406. However, in other embodiments, the pivot arm 404 may be positioned at any location on the vertical support 406 that allows the pivot arm 404 to be positioned at a height that is greater than a vehicle to be washed by the wrap around washing apparatus 400. A motor 460 is positioned on top of each pivot arm 404.

A mitter system 112 is attached to the pivot arm assemblies 402 at the spindle 130 of the mitter system 112. The spindle 130 is operatively attached to the motor 460 supported on the pivot arm 404 of the pivot arm assembly 402. In some embodiments, the spindle 130 may include the upper spindle portion 131 and the angled lower spindle portion 132, as shown in FIG. 1, so that the mitter frame 118 of the mitter system 112 is supported to be angled or tilted with respect to the pivot arm 404.

Operation of the motor 460 causes movement of the spindle 130. In some embodiments, the spindle 130 may be operated to rotate either clockwise or counterclockwise. Rotation of the spindle 130 causes rotation of the mitter frame 118, about a rotation axis 467 extending through the spindle 130. The mitter strips 120 rotate with the mitter frame 118 about the rotation axis 467. The tilt of the mitter frame 118 causes the mitter strips 120 to also move vertically as the mitter strips 120 rotate with the mitter frame 118 about the rotation axis 467.

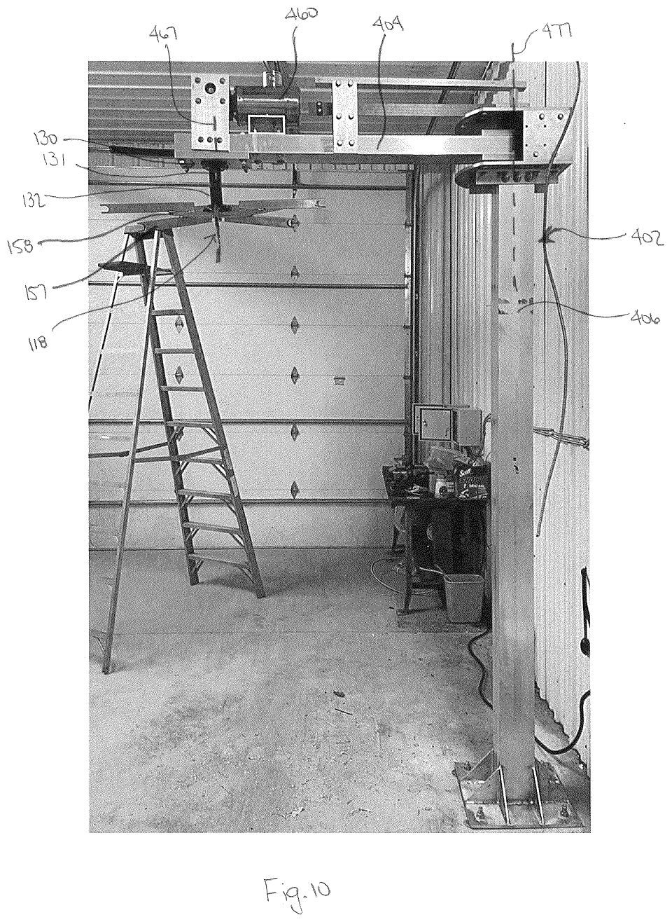

The pivot arm 404 of the pivot arm assembly 402 is rotatable about a vertical axis 477 extending longitudinally through the vertical support 406 (shown in FIG. 10), allowing the mitter system 112 supported by the pivot arm assembly 402 to move with respect to the vertical support 306. The pivot arm 404 may be rotatable using spring tension, hydro-pneumatic control, an electrical controller, or any other suitable method of rotating pivot arm 404 with respect to vertical support 406. In some embodiments, the pivot arm is rotatable about a 90 degree range of motion with respect to the vertical support. In some embodiments, the pivot arm is rotatable about a 180 degree range of motion with respect to the vertical support. In other embodiments, the range of pivot about the vertical support 406 could be greater or could be less, as desired. The movement of the pivot arm 404 with respect to the vertical support 306 allows the mitter system 112 to move along with or counter to the movement of a vehicle moving through the vehicle washing system 20.

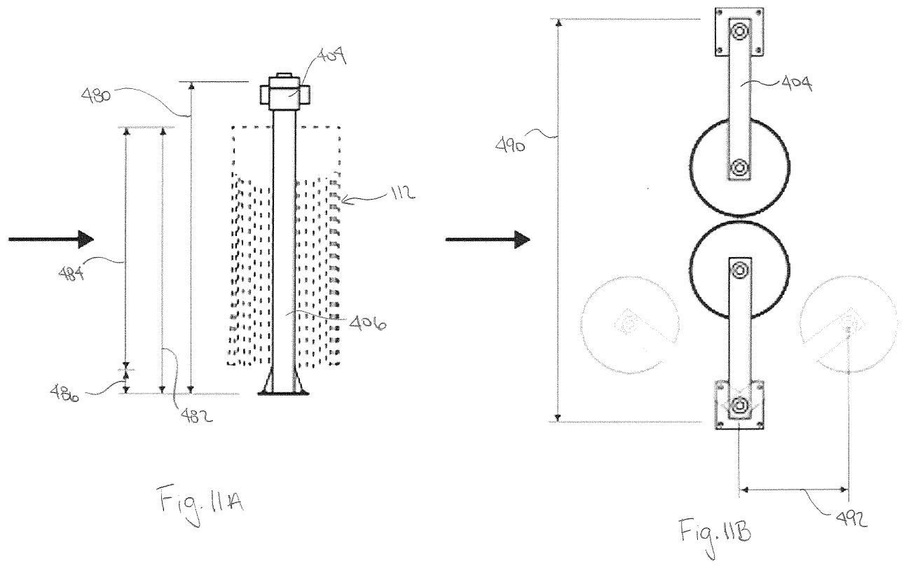

A diagram showing a side elevation view of the wrap around washing apparatus 200 is shown in FIG. 11A, and a diagram showing a top plan view of the wrap around washing apparatus 400 is shown in FIG. 11B. As shown in FIG. 11A, the wrap around washing apparatus 400 has an apparatus height 480 that includes the height of the entire structure including the frame 402. The wrap around washing apparatus 400 also includes an effective mitter height 482 that is measured from the top of the mitter system 112 to a support surface. The effective mitter height 482 includes a mitter height 484 that is measured from the top of the mitter system 112 to the bottom of the mitter system 112 and a floor to mitter height 486 that is measured from the support surface to the bottom of the mitter system 112.

As shown in FIG. 11B, the wrap around washing apparatus 400 also has an apparatus width 490 that spans between the vertical supports 406 of the aligned pivot arm assemblies 402. Additionally, the mitter system 112 has a pivot arm length 492.

In a representative example, the apparatus height 480 may be equal to 11 feet while the effective mitter height 482 is 96 inches. The mitter height 484 may be equal to 90 inches and the floor to mitter height 486 may be equal to 6 inches. Additionally, in this example, the apparatus width 490 may be equal to 12.5 feet, and the pivot arm length 492 may be equal to 3 feet and 4 inches. Therefore, the wrap around washing apparatus 400 in this example requires 6 feet and 8 inches of tunnel length within the vehicle washing system 20.

In operation, a first pivot arm assembly 402 is positioned on one side of a track for a vehicle to be washed and a second pivot arm assembly 402 may be aligned, e.g., across from or opposite to the first pivot arm assembly 402 on an opposite side of the track. The mitter systems 112 of the pivot arm assemblies 402 are across from one another, but spaced to allow the vehicle to pass between the mitter systems 112. As the vehicle passes through the mitter frames 118 of the mitter systems 112 or rotated by operating the motors 460 supported on the pivot arms 404. Pivot of the mitter frames 118 causes pivot of the mitter strips 420 and causes the mitter strips 420 to move vertically due to the tilt of the mitter frame 418. The mitter strips 420 come into contact with the vehicle to clean the surface of the vehicle.

The pivot arms 404 may also pivot with respect to the vertical supports 406 to move the mitter systems 112 along with the vehicle as the vehicle moves forward along the track or the vehicle may be held stationary as the pivot arms 404 move the mitter systems 112 with respect to the vehicle so that the mitter strips 120 contact and run across the surface of the vehicle.

The vehicle washing system 20 may be customizable to include a combination of one or all of the washing apparatuses in varying orders to provide different desired vehicle washing experiences. In one example, the vehicle washing system 20 may include, in series, the top washing apparatus 200, followed by the side washing apparatus 300, and then followed by the wrap around washing apparatus 400. In another example, the vehicle washing system 20 may start with the wrap around washing apparatus 400, then lead the vehicle to the top washing apparatus 200, and then finish with the side washing apparatus 300. In other examples, any of the top washing apparatus 200, side washing apparatus 300, or wrap around washing apparatus 400 may be used as a standalone system.

Some embodiments of the vehicle washing system may include novel cleaning mechanisms or techniques used for advancements in design of the mitter system 112, the assembled configurations of the mitter system 112, spray patterns, nozzle configurations, or any other suitable cleaning method that improves efficiency, effectiveness, or safety. For example, a vehicle washing system may comprise a cloth rotating mitter assembly that is optimized for efficient and gentle cleaning of the surface of a vehicle.

Some embodiments of the vehicle washing system may include advancements in automation and control systems that enhance the performance and functionality of the equipment used in the vehicle washing system. This could include features such as sensor-based controls, computerized monitoring and adjustment systems, or artificial intelligence algorithms that optimize the cleaning process. In one example, a car wash equipment system may include a computerized control unit configured to monitor vehicle dimensions, adjust cleaning parameters, and provide real-time feedback for optimal cleaning efficiency.

Some embodiments of the vehicle washing system may include water and resource management system. The water and resource management system may include water recycling and filtration, provide for efficient water usage, and/or provide for the integration of eco-friendly cleaning agents that minimize environmental impact. In one example, the vehicle washing system may include a water recycling and filtration module configured to collect, filter, and reuse water for multiple cleaning cycles.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1. A pivot arm assembly for a washing apparatus, the pivot arm assembly comprising:
a vertical support;
a pivot arm extending from said vertical support and pivotable with respect to said vertical support;
a spindle extending from said pivot arm, wherein said spindle includes an upper spindle portion and a lower spindle portion, and wherein said lower spindle portion is arranged at an acute angle with respect to said upper spindle portion;
a mitter frame coupled to said pivot arm at said lower spindle portion and a plurality of mitter strips attached to and extending downward from said mitter frame; and
wherein said pivot arm is pivotable about at least a 90 degree range of motion with respect to said vertical support.
